(19) United States
(12) Patent Application Publication
(10) Pub. No.: US 2005/0210720 A1
(43) Pub. Date: Sep. 29, 2005

(54) Apparatus for displaying interchangeable indicia

(76) Inventors: Jonathan Lee Burr, New Britain, CT (US); Lisa Stacy Burr, New Britain, CT (US)

Correspondence Address: Jonathan or Lisa Burr, 142 Roxbury Road, New Britain, CT, 06053, US

(21) Appl. No.: 11/091,870

(22) Filed: Mar. 28, 2005

Related U.S. Application Data
(60) Provisional application No. 60/557,083, filed on Mar. 26, 2004.

(51) Int. Cl. G09F 7/00; G09F 7/02

(52) U.S. Cl. 40/209; 40/611.03

(57) ABSTRACT

The present invention is an apparatus for displaying interchangeable indicia on a car or any other suitable surface. The invention comprises a frame body and a cover window. The frame body can mount to the mounting holes of a license plate on a car or other vehicle. The window cover protects a removable indicia displayed beneath it. The cover window is attached to the frame body. The indicia may be a full color image printed on paper, plastic film or other suitable media.

This application is based on Provisional No. 60/557083 filed Mar. 26, 2004, the priority of which is claimed.

### BACKGROUND OF THE INVENTION

The invention arose from the desire to create an alternative to messy bumper stickers. The idea of adhering a permanent message (bumper sticker) to one's car has become less and less popular in recent years, due to an increase in the popularity of purchasing and leasing brand new vehicles. Most people, however, still feel the need to share their opinions and passions, maybe more so in heightened patriotic times. Jonathan Burr, a native of Granby, Conn., had the idea to come up with an alternative to conventional bumper stickers in 1998. He knew people had a penchant to express themselves on their cars, but he also knew people were increasingly resistant to stick something permanent to their brand new car bumper. At the same time, he began to notice that more and more cars were sporting license plate frames and holders with dealer ads on them. As Mr. Burr wondered whether all those new car owners were such completely satisfied customers that they actually intended to advertise the dealers (doubtful), he began to connect conventional bumper stickers with license plate frames, and an idea started brewing. Hence, the birth of the “The TrafficTalker”.

### SUMMARY OF THE INVENTION

The invention is an apparatus for displaying interchangeable indicia, which may be mounted to any suitable mounting surface, including a vehicle in the license plate area, with or without framing a license plate. Unlike traditional license plate frames that are pre-formed or silk-screened with permanent letters and logos to advertise a merchant, and conventional glued bumper stickers that may spout a special interest, TrafficTalker offers a way to both display personal messages and to change them; whenever desired, with no special tools or hardware, and without having to remove the frame from the vehicle. Needing just simple do-it-yourself installation, the TrafficTalker is a device which can be used as a license plate holder with a message area featuring a clear, flip-down cover. One can easily insert, remove and change messages under the cover using printed “mini-banners”.

### DETAILED DESCRIPTION

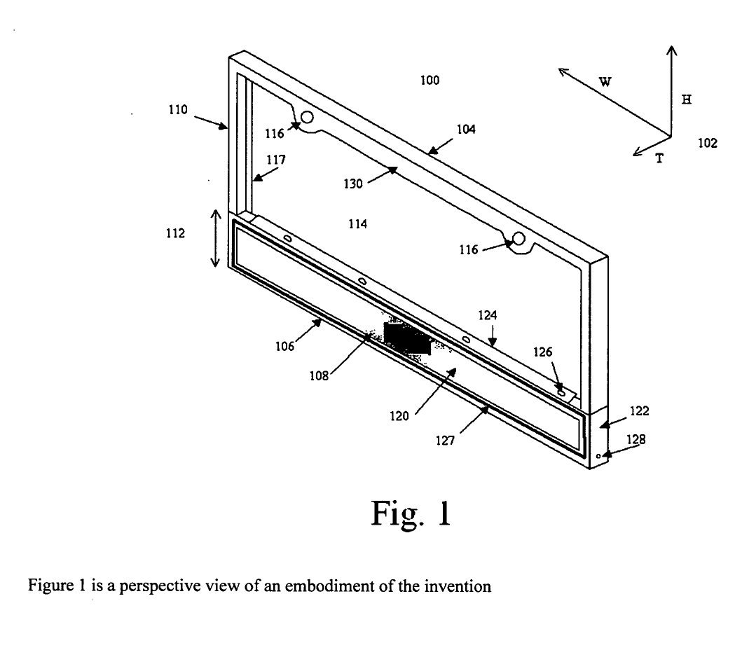

An embodiment 100 of the present invention is illustrated in FIG. 1. Embodiment 100 comprises a frame body 104 and a cover window 106. Indicium 108 is visible through the cover window.

The frame body comprises thin frame 110 and display area 112. The thin frame and display area form a license plate opening 114. The top of the thin frame comprises mounting holes 116.

As used herein, the terms “width”, “height”, and “thickness” correspond to the dimension of an illustrated item as indicated by axes 102 unless otherwise indicated. W corresponds to width. H corresponds to height. T corresponds to thickness.

The height and width of the frame body are selected such that the frame body fits around a license plate. For most license plates in the US, a suitable height of the frame body is 6.28 inches (15.9 cm) and a suitable width is 12.31 inches (31.3 cm). Other jurisdictions may require different frame dimensions to accommodate different sized license plates.

The thickness of the frame body is selected such that the edges of the frame body rest against the car the frame body is mounted on. Recess 117 is provided around the periphery of the frame body to accommodate the license plate. Thus the sides of the license plate are protected by the sides of the frame body.

The display area is dimensioned as large as practical without unduly obscuring the license plate numerals and other information, which must be legally displayed. For many states within the United States, a display area height of 1.75 inches (4.45 cm) is suitable.

Mounting holes 116 are provided to attach the frame body to a car. The mounting holes correspond to the mounting holes of a license plate. The screws normally used to mount a license plate to a car are passed through mounting holes 116 and then through the corresponding holes of a license plate. The assembly is then attached to a car by screwing in the mounting screws to the threaded receiving holes on a car.

The mounting holes are large enough to allow the mounting screws to pass through. The holes may be slots to allow for adjustment of the position of the frame body. A suitable width for the mounting holes is 0.28 inches (0.71 cm). A suitable height for the mounting holes is 0.44 inches (1.12 cm).

The frame body may be made of any material suitable for mounting on a car or other vehicle. The material should be tough enough to withstand shock and vibration. It should be inert enough to tolerate exposure to sand, salt, dirt, the sun's UV radiation and other environmental factors it may be exposed to. Suitable materials include plastic and metal. A preferred material is impact resistant fiberglass filled nylon such as that used in the manufacture of the handles for handguns.

A suitable color is black. Any color or finish, however, is suitable.

The frame body may include a variety of decorations. Space 130 between the mounting holes, for example, might have a trademark or other indicia molded, imprinted or otherwise presented there between.

The window cover comprises a face 120, sidewalls 122 and top lip 124. The top lip comprises down facing dimples 126.

The top lip and sidewalls serve to help keep water and dirt away from indicium 108. O-ring 127 surrounding the indicium may also be present.

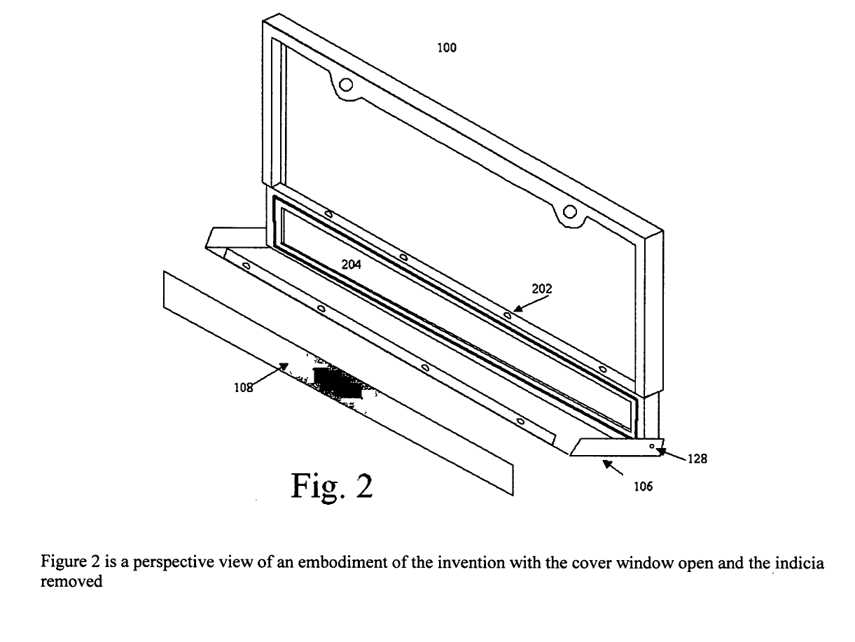

The dimples in the top lip serve to hold the cover window in place. The dimples fit into corresponding divots (FIG. 2, 202) in the frame body. The cover window has enough flexibility and the dimples and divots are dimensions such that the strength of an average man or woman is sufficient to open the cover window or snap it into place.

The window cover can be made of any clear material suitable for the environment of a license plate. UV resistant polycarbonate is a suitable material.

The cover window may have a composite structure such as a glass window mounted in a metal frame.

In embodiment 100, the cover window is attached to the frame body by hinge 128. The hinge may comprise a dimple in the frame body. The dimple fits into a corresponding divot or hole in the sidewall of the cover window.

FIG. 2 is a perspective view of embodiment 100 with the cover window open and indicium 108 removed.

Recess 204 is visible. The recess is provided to hold the indicium. This allows the cover window and the frame body to form a seal around the indicium when the widow cover is closed.

A suitable height for the recess is 1.19 inches (3.02 cm). A suitable width for the recess is 11.75 inches (29.85 cm). A suitable thickness for the recess is in the range of 0.005 inches (0.0127 cm) to 0.01 inches (0.0254 cm). This thickness range corresponds to 1× to 2× of the thickness of a typical piece of paper. Other thicknesses may be suitable for other indicia material.

Suitable indicia are a design, text or combination of both printed on a flexible thin film, such as paper or plastic. The design, text or combination may be in full color. The indicia may be anything suitable for legal display in public. This includes but is not limited to political affiliation, advertising, personal statements, seasonal greetings and fraternal associations.

The indicia may be held in place by glue or other adhesive means. A rubber type adhesive allows easy removal when changing indicia.

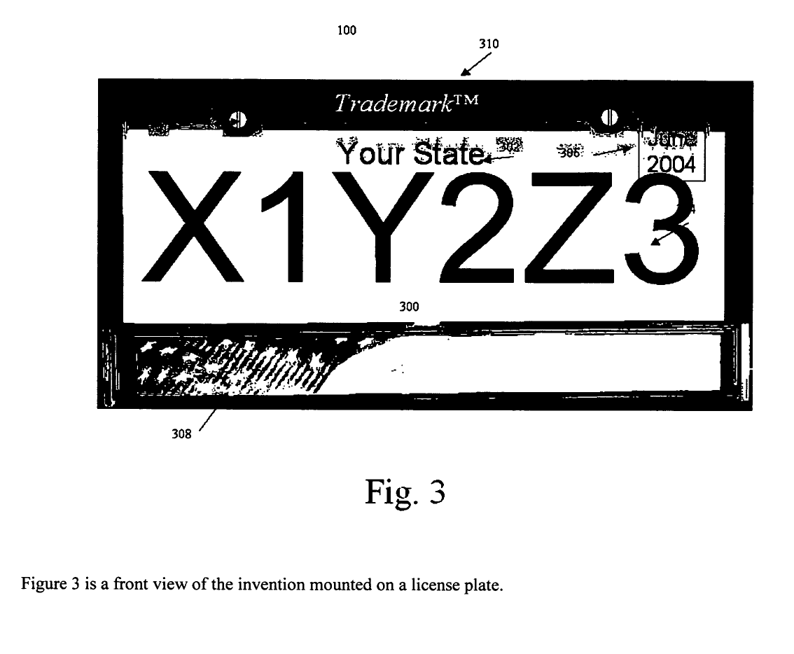

FIG. 3 is a front view of embodiment 100 mounted over license plate 300 and on the rear of a car. Screws 301 hold the assembly in place. The necessary information on the license plate such as the state 302, license plate number 304 and expiration sticker 306 are clearly visible.

Indicium 308 is visible through the cover window. Indicium 308 is a stylized American Flag in this example.

A trademark 310 has been molded in the top of the frame body. The frame body is black. The trademark is shown in white.

Means other than a hinge may be used to attach the cover window to the frame body. These means include:
A permanent attachment with a side slot to allow for changing of the indicia
A snap-on attachment where the cover window is completely removed when changing indicia
A slot in the frame body where the cover window and indicia slide in together

Embodiment 100 may be mounted upside down.

In an alternative embodiment, the frame body may comprise only a display area and either:
Mounting holes;
Clips by which to attach the display panel to the edge of the license plate; or
Peepers to press into the unused holes on the license plate.

The frame body in this embodiment would not surround the license plate.

The present invention enables a new means of advertising. A car owner could rent out the space on their car for suitable advertising. The advertising could be sold over the Internet. Indicia could be downloaded and printed on a person's personal computer and then placed in the invention. The present invention enables a new means of advertising specialty, promotion or premium. A business could permanently imprint their company or organization name in the top area and insert a slogan or campaign message in the display area, or allow the recipient to customize their own display message via the internet or on their own computer, thus allowing for a useful item to give away as a promotion. The present invention can be combined with the Internet to perform an improved method of market research. Multiple offerings of the invention with a variety of indicia can be offered for sale such as on ebay® (www.ebay.com, last viewed Mar. 12, 2004). The location and ultimate bid price of the invention with particular indicia can be tracked to determine the market price and geographic, demographic and other market segmentation parameters indicating preferences for indicia of different classes. This information can be used to determine mass marketing programs of this invention or more conventional license plate frames with permanent indicia. The improved method for market research, for example, revealed previously unknown markets in Canada, United States and Australia for indicia indicating dog breed preferences. The improved method of market research can be applied to other generic items available with a variety of indicia. The invention also enables a new form of fund raising. Owners of embodiment 100 or other comparable embodiments can purchase messages of support for particular organizations. The purchase price becomes a charitable contribution. The purchaser further supports the organization by displaying the indicia. The invention also enables a new form of vehicle identification. Businesses and organizations can utilize embodiment 100 or other comparable embodiment to identify vehicles for the purposes of fleet identification, parking or entrance permit, member or staff identification. The invention also enables a new form of personal expression. Owners of embodiment 100 or other comparable embodiment can purchase via the Internet or create their own custom messages to express their views or thoughts on virtually any subject matter. This eliminates the need to use permanent bumper or window stickers, which may be less desirable on new or leased vehicles.

1. An apparatus which can be used to display interchangeable indicia comprised of:
(a) a body;
(b) a cover window; which
opens to allow insertion of media
closes to protect the media
is of a clear material allowing for the indicia to be viewed
(c) mounting holes;
1. which can be used to mount the device on a vehicle in the license plate area
2. which can be used to mount the apparatus onto any suitable surface

2. In an alternative embodiment, the frame body may comprise only a display area and either:
Mounting holes;
Clips by which to attach the display panel to the edge of the license plate; or
Peepers to press into the unused holes on the license plate.
